(19) United States
(12) Patent Application Publication
(10) Pub. No.: US 2008/0029502 A1
(43) Pub. Date: Feb. 7, 2008

(54) Electromagnetic-field-shielded heating wire used in bedding and apparatus for driving the same

(76) Inventors: Han Sung You, Seoul (KR); Kum Ja Min, Seoul (KR)

Correspondence Address: CANTOR COLBURN, LLP, 55 GRIFFIN ROAD SOUTH, BLOOMFIELD, CT, 06002, US

(21) Appl. No.: 11/882,364

(22) Filed: Aug. 1, 2007

(30) Foreign Application Priority Data
Aug. 4, 2006 (KR) 10-2006-0073832
Oct. 10, 2006 (KR) 10-2006-0098362
May 4, 2007 (KR) 10-2007-0043430
Jun. 21, 2007 (KR) 10-2007-0061075

(51) Int. Cl. H05B 1/00

(52) U.S. Cl. 219/212

(57) ABSTRACT

Provided are an electromagnetic-field-shielded heating wire used in bedding and an apparatus for driving the same. The heating wire includes a core wire which is formed of a copper or enamel wire, a first insulating inner coating which is coated on an outer surface of the core wire to encompass an outer circumferential surface of the core wire, a heater wire which is wound on an outer circumferential surface of the first insulating inner coating, a second insulating inner coating which is coated on an outer surface of the first insulating inner coating to encompass the outer circumferential surface of the first insulating inner coating including the heater wire, a ground wire which is formed on an outer circumferential surface of the second insulating inner coating, and a metallic thin film which is coated on the outer circumferential surface of the second insulating inner coating including the ground wire.

### CROSS-REFERENCE TO RELATED PATENT APPLICATIONS

This application claims the benefit of Korean Patent Application No. 10-2006-0073832, filed on Aug. 4, 2006, 10-2006-0098362, filed on Oct. 10, 2006, 10-2007-0043430, filed on May 4, 2007, and 10-2007-0061075, filed on Jun. 21, 2007, in the Korean Intellectual Property Office, the disclosures of which are incorporated herein in its entirety by reference.

### BACKGROUND OF THE INVENTION

1. Field of the Invention

The present invention relates to an electromagnetic-field-shielded heating wire used in bedding and apparatus for driving the same, and more particularly, to an electromagnetic-field-shielded heating wire used in bedding in which a heater wire of an electromagnetic-field-shielded heating wire is formed of pure iron so that temperature can be precisely controlled without using an additional temperature sensing wire, the amount of energy consumed can be reduced as heat rises, an electromagnetic field can be shielded and fire can be prevented from occurring due to an overcurrent etc., and apparatus for driving the same.

2. Description of the Related Art

In general, electric heat beddings are tools which provide heating at a uniform temperature by generating heat by changing an electric energy into a heat energy, such as an electric blanket, an electric floor paper, an electric mat and an electric carpet etc.

Such electric heat beddings include a temperature controlling device which arranges a heating wire inside lagging at predetermined intervals and controls power supplied to the heating wire so as to keep a predetermined temperature that is set by a user at an end of the heating wire.

In addition, in the electric heat beddings, a temperature sensor for sensing temperature heated in the heating wire and controlling temperature by controlling power supplied to the heating wire must be installed in the form of a chip at a predetermined position inside the electric heat beddings.

However, in the conventional electric heat beddings, since the temperature sensor for sensing temperature is installed at a predetermined position of the electric heat beddings, as described above, the temperature sensor does not sense the whole temperature of the beddings but only the temperature at a location in which the temperature sensor is installed, to control power applied to the electric heat beddings. Thus, when a portion in which the temperature sensor is installed is overheated, folded or overlapped, due to sensing of temperature at a portion of the electric heat beddings, temperature control has been abnormally performed.

In details, since temperature is detected by installing an additional temperature sensor that is separated from the heating wire, the temperature of the entire heating wire generated due to short inside the heating wire cannot be detected and partial overheat at an arbitrary location cannot be detected such that temperature control is abnormally performed. In addition, if the heating wire is partially overheated or shorted, fire and an electric shock accident may occur.

### SUMMARY OF THE INVENTION

The present invention provides an electromagnetic-field-shielded heating wire used in bedding in which a heater wire of an electromagnetic-field-shielded heating wire is formed of pure iron so that temperature can be precisely sensed in the front of an electric heat bedding and an electromagnetic field can be shielded by coating a ground wire and a metallic thin film on an outer covering.

The present invention also provides an electromagnetic-field-shielded heating wire used in bedding in which a core or heater wire is formed of pure iron so that temperature can be precisely controlled without using an additional temperature sensor, an insulating paper is used to improve an insulation property and the amount of energy consumed can be reduced as heat rises.

The present invention also provides an apparatus for driving an electromagnetic-field-shielded heating wire used in bedding in which, if power is abnormally supplied like that an overcurrent is supplied to the electromagnetic-field-shielded heating wire, power can be immediately cut off.

According to an aspect of the present invention, there is provided an electromagnetic-field-shielded heating wire used in bedding, the heating wire comprising: a core wire which is formed of a copper or enamel wire; a first insulating inner coating which is coated on an outer surface of the core wire to encompass an outer circumferential surface of the core wire; a heater wire which is wound on an outer circumferential surface of the first insulating inner coating; a second insulating inner coating which is coated on an outer surface of the first insulating inner coating to encompass the outer circumferential surface of the first insulating inner coating including the heater wire; a ground wire which is formed on an outer circumferential surface of the second insulating inner coating; and a metallic thin film which is coated on the outer circumferential surface of the second insulating inner coating including the ground wire.

According to another aspect of the present invention, there is provided an electromagnetic-field-shielded heating wire used in bedding, the heating wire comprising: a core wire which is enamel-coated on a pure iron wire; a first insulating coating which is coated on an outer surface of the core wire to encompass an outer circumferential surface of the core wire; a heater wire which is wound on an outer circumferential surface of the first insulating coating and formed of an enamel-coated pure iron (Fe) wire; a second insulating coating which is coated on the outer circumferential surface of the first insulating coating including the heater wire; a ground wire which is formed on an outer circumferential surface of the second insulating coating; and an insulating paper which is wound on the outer circumferential surface of the second insulating coating including the ground wire.

According to another aspect of the present invention, there is provided an electromagnetic-field-shielded heating wire used in bedding, the heating wire comprising: a core wire which is enamel-coated on a copper wire or pure iron wire; an insulating inner coating which is coated on an outer surface of the core wire to encompass an outer circumferential surface of the core wire; an insulating paper which is coated on an outer circumferential surface of the insulating inner coating; a heater wire which is formed of pure iron (Fe) wound on an outer circumferential surface of the insulating paper; and an insulating outer coating which is coated on the outer circumferential surface of the insulating paper including the heater wire.

According to another aspect of the present invention, there is provided an electromagnetic-field-shielded heating wire used in bedding, the heating wire comprising: a core wire which is formed of a copper wire or pure iron wire; a first insulating inner coating which is coated on an outer surface of the core wire to encompass an outer circumferential surface of the core wire; a first insulating paper which is wound on an outer circumferential surface of the first insulating inner coating; a heater wire which is formed of pure iron (Fe) wound on an outer circumferential surface of the first insulating paper; a second insulating inner coating which is coated on an outer circumferential surface of the first insulating paper including the heater wire; a second insulating paper which is coated on an outer circumferential surface of the second insulating inner coating; a ground wire which is formed on an outer circumferential surface of the second insulating paper; a metallic thin film which is coated on the outer circumferential surface of the second insulating paper including the ground wire; and an insulating outer coating which is coated on an outer circumferential surface of the metallic thin film.

According to another aspect of the present invention, there is provided an electromagnetic-field-shielded heating wire used in bedding, the heating wire comprising: a core wire which is formed of a copper wire or pure iron wire; a first insulating inner coating which is coated on an outer surface of the core wire to encompass an outer circumferential surface of the core wire; a first insulating paper which is wound on an outer circumferential surface of the first insulating inner coating; a heater wire which is coated on an outer circumferential surface of the first insulating paper and is formed of pure iron (Fe); a second insulating inner coating which is coated on an outer circumferential surface of the first insulating paper including the heater wire; a second insulating paper which is coated on an outer circumferential surface of the second insulating inner coating; a shield wire which is formed on an outer circumferential surface of the second insulating paper; and an insulating outer coating which is formed on an outer circumferential surface of the heating wire including the shield wire.

According to another aspect of the present invention, there is provided an electromagnetic-field-shielded heating wire used in bedding, the heating wire comprising: a core wire which is formed of thread; a heater wire which is formed of a pure iron wire wound on an outer circumferential surface of the core wire; an insulating inner coating which is coated to encompass the heater wire including the core wire; an insulating paper which is coated on the outer circumferential surface of the insulating inner coating; a ground wire which is formed on an outer circumferential surface of the insulating paper; a metallic thin film which is coated on the outer circumferential surface of the insulating paper including the ground wire; and an insulating outer coating which is formed on an outer circumferential surface of the metallic thin film.

According to another aspect of the present invention, there is provided an electromagnetic-field-shielded heating wire used in bedding, the heating wire comprising: a heater wire which functions as a core wire and is formed of pure iron; an insulating inner coating which is coated on an outer circumferential surface of the heater wire; an insulating paper which is coated on the outer circumferential surface of the insulating inner coating; a ground wire which is formed on an outer circumferential surface of the insulating paper; a metallic thin film which is coated on the outer circumferential surface of the insulating paper including the ground wire; and an insulating outer coating which is formed on an outer circumferential surface of the metallic thin film.

According to another aspect of the present invention, there is provided an apparatus for driving an electromagnetic-field-shielded heating wire used in bedding, the apparatus comprising: an electromagnetic-field-shielded heating wire which includes a heater wire and generates heat if power is supplied to the electromagnetic-field-shielded heating wire; a safety circuit which is automatically cut off if an overvoltage is generated in commercial power; an electromagnetic wave sensing circuit which senses that an electromagnetic field is generated in the heating wire; a constant-voltage circuit which rectifies and smoothens the commercial power to supply a DC (direct current) to each unit; a heating wire driving unit which supplies the commercial power to the heating wire; a shunt voltage detecting circuit which detects a shunt voltage of the heating wire; a heat setting circuit which sets heating of the heating wire; a display unit which displays that power is being supplied to the heating wire and displays that an error occurs in the heating wire; and a controller which applies a control signal to the heating wire driving unit according to setting of the heat setting circuit and a current of the heating wire detected by the shunt voltage detecting circuit, controls the apparatus to compare the current of the heating wire detected by the shunt voltage detecting circuit with a reference value, if the current of the heating wire is lager than the reference value, to determine that an error occurs in the heating wire, to cut off power supplied to the heating wire and to display that the power is cut off.

According to another aspect of the present invention, there is provided an apparatus for driving an electromagnetic-field-shielded heating wire used in bedding, the apparatus comprising: a heating unit which generates heat if power is supplied to the heating unit and in which resistance is increased as temperature rises; a safety circuit which cuts off power supply automatically if an overvoltage is generated to commercial power; an electric-potential checking circuit which checks that an electromagnetic wave is generated in the heating unit, to allow a terminal to be grounded with the earth through a plug; a constant-voltage circuit which rectifies and smoothens the commercial power supplied to the heating unit to supply a DC (direct current) power to each unit; output circuit which switches supply of the commercial power to the heating unit; a temperature setting circuit which sets heating temperature of the heating unit; a temperature detecting circuit which detects temperature of the heating unit; an overcurrent protecting circuit which, if an overcurrent is generated in the heating unit through the temperature detecting circuit, outputs a control signal to the temperature setting circuit so that power cannot be supplied to the heating unit regardless of the set value of the temperature setting circuit; a temperature comparing circuit which compares a voltage caused by temperature setting of the temperature setting circuit with a voltage caused by temperature detecting of the temperature detecting circuit and outputs a control signal so that the output circuit can supply or cannot supply the commercial power to the heating unit; and a time generating circuit which, if the temperature comparing circuit outputs a control signal so that the commercial power cannot be supplied to the heating unit, controls the apparatus to supply the commercial power to the heating unit for a short time so as to detect temperature.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the structure of an electromagnetic-field-shielded heating wire used in bedding according to an embodiment of the present invention;

FIG. 2 illustrates the structure of an electromagnetic-field-shielded heating wire used in bedding according to another embodiment of the present invention;

FIG. 3 illustrates the structure of an electromagnetic-field-shielded heating wire used in bedding according to another embodiment of the present invention;

FIG. 4 is a table showing resistances according to the temperature of pure iron used for a heater wire in the electromagnetic-field-shielded heating wire used in bedding according to the present invention;

FIG. 5 is a graph showing resistance versus the temperature of pure iron used for a heater wire in the electromagnetic-field-shielded heating wire used in bedding according to the present invention;

FIG. 6 illustrates the structure of an electromagnetic-field-shielded heating wire used in bedding according to another embodiment of the present invention;

FIG. 7 illustrates the structure of an electromagnetic-field-shielded heating wire used in bedding according to another embodiment of the present invention;

FIG. 8 illustrates the structure of an electromagnetic-field-shielded heating wire used in bedding according to another embodiment of the present invention;

FIG. 9 illustrates the structure of an electromagnetic-field-shielded heating wire used in bedding according to another embodiment of the present invention;

FIG. 10 is a graph comparing a change in temperature and resistance of the electromagnetic-field-shielded heating wires used in bedding illustrated in FIGS. 1 through 3 with a change in temperature and resistance of the electromagnetic-field-shielded heating wire used in bedding illustrated in FIGS. 6 through 9;

FIG. 11 illustrates the structure of an electromagnetic-field-shielded heating wire used in bedding according to another embodiment of the present invention;

FIG. 12 illustrates the structure of an electromagnetic-field-shielded heating wire used in bedding according to another embodiment of the present invention;

FIG. 13 illustrates an apparatus for driving an electromagnetic-field-shielded heating wire used in bedding, according to an embodiment of the present invention;

FIG. 14 is a block diagram illustrating an apparatus for driving an electromagnetic-field-shielded heating wire used in bedding, according to another embodiment of the present invention;

FIG. 15 is a detailed circuit diagram illustrating an example of the apparatus for driving an electromagnetic-field-shielded heating wire used in bedding illustrated in FIG. 14; and

FIG. 16 is a detailed circuit diagram illustrating another example of the apparatus for driving an electromagnetic-field-shielded heating wire used in bedding illustrated in FIG. 14.

### DETAILED DESCRIPTION OF THE INVENTION

The present invention will now be described in greater detail with reference to the accompanying drawings, in which exemplary embodiments of the invention are shown.

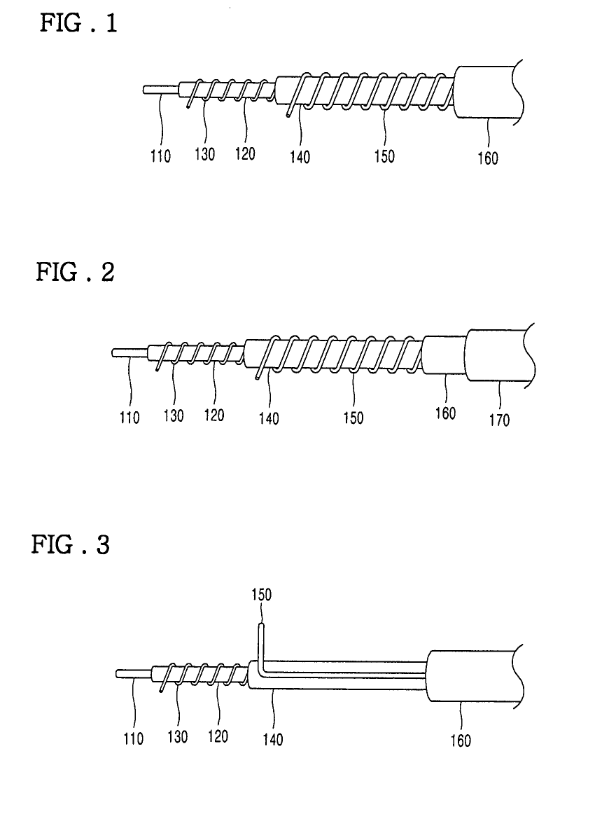

FIG. 1 illustrates the structure of an electromagnetic-field-shielded heating wire used in bedding according to an embodiment of the present invention.

As illustrated in FIG. 1, an electromagnetic-field-shielded heating wire used in bedding according to an embodiment of the present invention includes a core wire 110 that is formed of a copper or enamel wire, a first insulating inner coating 120 that is coated on an outer surface of the core wire 110 to encompass an outer circumferential surface of the core wire 110, a heater wire 130 that is wound on an outer circumferential surface of the first insulating inner coating 120, a second insulating inner coating 140 that is coated on an outer surface of the first insulating inner coating 120 to encompass the outer circumferential surface of the first insulating inner coating 120 including the heater wire 130, a ground wire 150 that is formed of a copper wire, for example, and wound on an outer circumferential surface of the second insulating inner coating 140, and a metallic thin film 160 that is coated on the outer circumferential surface of the second insulating inner coating 140 to encompass the second insulating inner coating 140 including the ground wire 150.

Here, the heater wire 120 is formed of pure iron, Fe, having purity of 99.9% or higher, and an insulating material, such as nylon, Teflon or silicon, is used to form the first and second insulating inner coatings 120 and 140. In addition, the metallic thin film 160 is an aluminum thin film or silver foil film (silver paper).

FIG. 2 illustrates the structure of an electromagnetic-field-shielded heating wire used in bedding according to another embodiment of the present invention.

As illustrated in FIG. 2, an electromagnetic-field-shielded heating wire used in bedding according to another embodiment of the present invention is the same as that illustrated in FIG. 1 except that the electromagnetic-field-shielded heating wire used in bedding further includes an insulating outer coating 170 that is formed of PVC, silicon or Teflon and coated on an outer circumferential surface of the metallic thin film 160 to encompass the metallic thin film 160.

FIG. 3 illustrates the structure of an electromagnetic-field-shielded heating wire used in bedding according to another embodiment of the present invention.

As illustrated in FIG. 3, an electromagnetic-field-shielded heating wire used in bedding according to another embodiment of the present invention is the same as that illustrated in FIG. 1 except that the ground wire 150 is not wound on the second insulating inner coating 140 but is disposed between the second insulating inner coating 140 and the metallic thin film 160 to be long along the heating wire. That is, the ground wire 150 is formed on an outer circumferential surface of the second insulating inner coating 140 to be long in a lengthwise direction of the electromagnetic-field-shielded heating wire, and the metallic thin film 160 is coated on the outer circumferential surface of the second insulating inner coating 140 to be overlapped with the outer circumferential surface of the second insulating inner coating 140 including the ground wire 150.

Here, the electromagnetic-field-shielded heating wire used in bedding illustrated in FIG. 3 may further include an insulating outer coating that is formed of PVC, silicon or Teflon and coated on an outer circumferential surface of the metallic thin film 160 to encompass the metallic thin film 160.

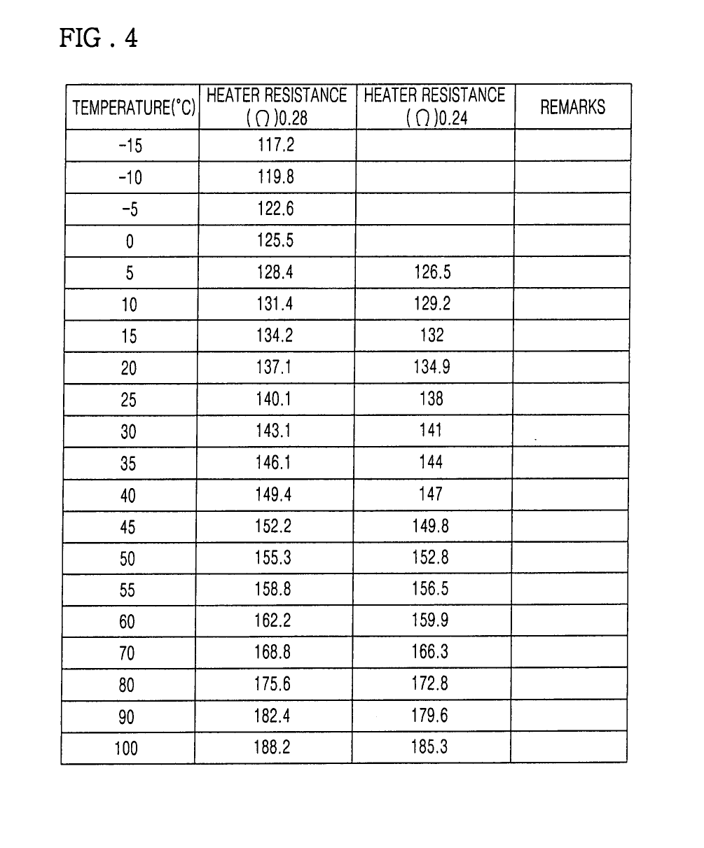

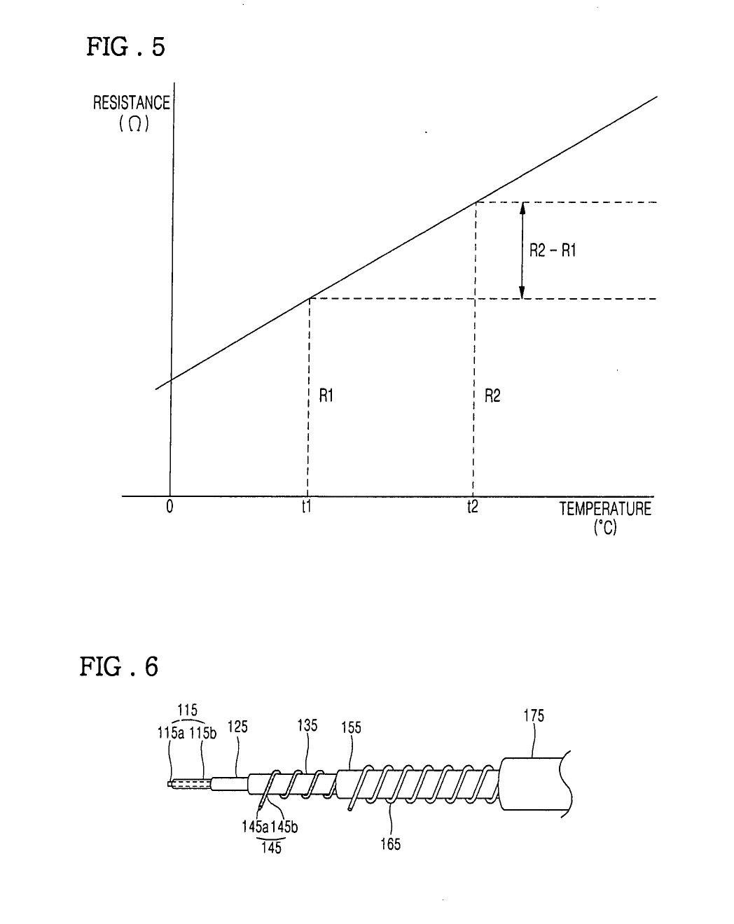

FIG. 4 is a table showing resistances according to the temperature of a heater wire according to the present invention, and FIG. 5 is a graph showing resistance versus the temperature of a heater wire.

As shown in FIGS. 4 and 5, the present invention uses pure iron to form the heater wire 130 and thus, a change in resistance according to temperature has a uniform inclination. Thus, the temperature of the heating wire can be precisely measured.

Furthermore, the pure iron has a relatively small width of a change in resistance according to temperature (smooth inclination) and thus, as heat rises, the amount of energy consumed is reduced.

In the heating wires illustrated in FIGS. 1 through 3, a core wire is formed of a copper or enamel wire and a heater wire is formed of pure iron. However, as a result of recent experiments in which a core wire is not formed of a copper or enamel wire but a pure iron wire, a width of a change in resistance according to temperature is smaller (smooth inclination) and as heat rises, the amount of energy consumed is reduced.

Electromagnetic-field-shielded heating wires used in bedding, each of which core wire is formed of a pure iron wire according to another embodiments of the present invention will now be described in detail.

FIG. 6 illustrates the structure of an electromagnetic-field-shielded heating wire used in bedding according to another embodiment of the present invention.

As illustrated in FIG. 6, an electromagnetic-field-shielded heating wire used in bedding according to another embodiment of the present invention includes a core wire 115 that is enamel 115b-coated on a pure iron wire 115a, a first insulating coating 125 that is coated on an outer surface of the core wire 115 to encompass an outer circumferential surface of the core wire 115, a first insulating paper 135 that is wound on an outer circumferential surface of the first insulating coating 125, a heater wire 145 that is wound and enamel 145b-coated on an outer surface of the first insulating paper 135, a second insulating coating 155 that is coated on an outer surface of the first insulating paper 135 including the heater wire 145, a ground wire 165 that is formed of a copper wire, for example, and wound on an outer circumferential surface of the second insulating coating 155, and a second insulating paper 175 that is wound on the outer circumferential surface of the second insulating coating 155 including the ground wire 165.

Here, the pure iron wire has purity of 99.9% or higher, and an insulating material, such as nylon, Teflon or silicon, is used to form the first and second insulating coatings 125 and 155.

In FIG. 6, the ground wire 165 is wound on the outer circumferential surface of the second insulating coating 155. However, the present invention is not limited to this. In details, the ground wire 165 is not wound on the second insulating coating 155 but is disposed between the second insulating coating 155 and the second insulating paper 175 to be long along the heating wire. That is, the ground wire 165 is formed on an outer circumferential surface of the second insulating coating 155 to be long in a lengthwise direction of the electromagnetic-field-shielded heating wire.

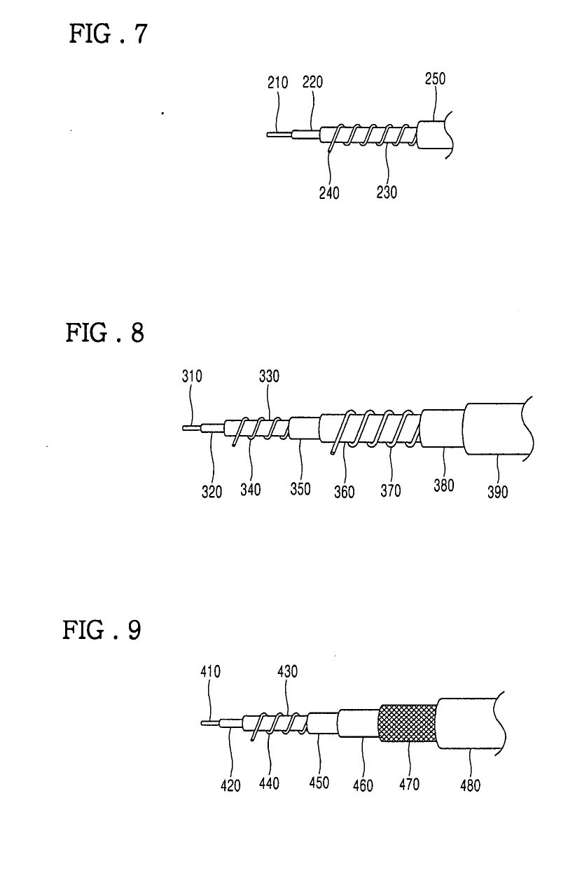

FIG. 7 illustrates the structure of an electromagnetic-field-shielded heating wire used in bedding according to another embodiment of the present invention.

As illustrated in FIG. 7, an electromagnetic-field-shielded heating wire used in bedding according to another embodiment of the present invention includes a core wire 210 that is enamel-coated on a copper or pure iron wire, an insulating coating 220 that is coated on an outer surface of the core wire 210 to encompass an outer circumferential surface of the core wire 210, an insulating paper 230 that is wound on an outer circumferential surface of the insulating coating 220, a heater wire 240 that is formed of a pure iron wire wound on an outer surface of the insulating paper 230, and an insulating outer coating 250 that is formed of PVC, silicon or Teflon coated on an outer surface of the insulating paper 230 including the heater wire 240.

Here, the pure iron wire has purity of 99.9% or higher, and an insulating material, such as nylon, Teflon or silicon, is used to form the insulating coating 220.

FIG. 8 illustrates the structure of an electromagnetic-field-shielded heating wire used in bedding according to another embodiment of the present invention.

As illustrated in FIG. 8, an electromagnetic-field-shielded heating wire used in bedding according to another embodiment of the present invention includes a core wire 310 that is enamel-coated on a copper or pure iron wire, a first insulating inner coating 320 that is coated on an outer surface of the core wire 310 to encompass an outer circumferential surface of the core wire 310, a first insulating paper 330 that is wound on an outer circumferential surface of the first insulating inner coating 320, a heater wire 340 that is formed of a pure iron wire wound on an outer surface of the first insulating paper 330, a second insulating inner coating 350 that is coated on an outer surface of the first insulating paper 330 including the heater wire 340, a second insulating paper 360 that is coated on an outer circumferential surface of the second insulating inner coating 350, a ground wire 370 that is formed of a copper wire, for example, and wound on an outer circumferential surface of the second insulating paper 360, a metallic thin film 380 that is formed of an aluminum thin film or a silver paper coated on the outer circumferential surface of the second insulating paper 360, and an insulting outer coating 390 that is formed on an outer circumferential surface of the heating wire including the metallic thin film 380.

Here, the pure iron wire has purity of 99.9% or higher, and an insulating material, such as nylon, Teflon or silicon, is used to form the first and second insulating inner coatings 320 and 350. In addition, the insulating outer coating 390 is formed of PVC, silicon or Teflon.

In addition, in FIG. 8, the ground wire 370 is wound on the outer circumferential surface of the second insulating paper 360. However, the present invention is not limited to this. In details, the ground wire 370 is not wound on the second insulating paper 360 but is disposed between the second insulating paper 360 and the metallic thin film 380 to be long along the heating wire. That is, the ground wire 370 is formed on an outer circumferential surface of the second insulating paper 360 to be long in a lengthwise direction of the electromagnetic-field-shielded heating wire.

FIG. 9 illustrates the structure of an electromagnetic-field-shielded heating wire used in bedding according to another embodiment of the present invention.

As illustrated in FIG. 9, an electromagnetic-field-shielded heating wire used in bedding according to another embodiment of the present invention includes a core wire 410 that is enamel-coated on a copper or pure iron wire, a first insulating inner coating 420 that is coated on an outer surface of the core wire 410 to encompass an outer circumferential surface of the core wire 410, a first insulating paper 430 that is wound on an outer circumferential surface of the first insulating inner coating 420, a heater wire 440 that is formed of a pure iron wire wound on an outer surface of the first insulating paper 430, a second insulating inner coating 450 that is coated on an outer surface of the first insulating paper 430 including the heater wire 440, a second insulating paper 460 that is coated on an outer circumferential surface of the second insulating inner coating 450, a shield wire 470 that is formed on an outer surface of the second insulating paper 460, and an insulting outer coating 480 that is formed on an outer circumferential surface of the heating wire including the shield wire 470.

Here, the pure iron wire has purity of 99.9% or higher, and an insulating material, such as nylon, Teflon or silicon, is used to form the first and second insulating inner coatings 420 and 450. In addition, the insulating outer coating 480 is formed of PVC, silicon or Teflon.

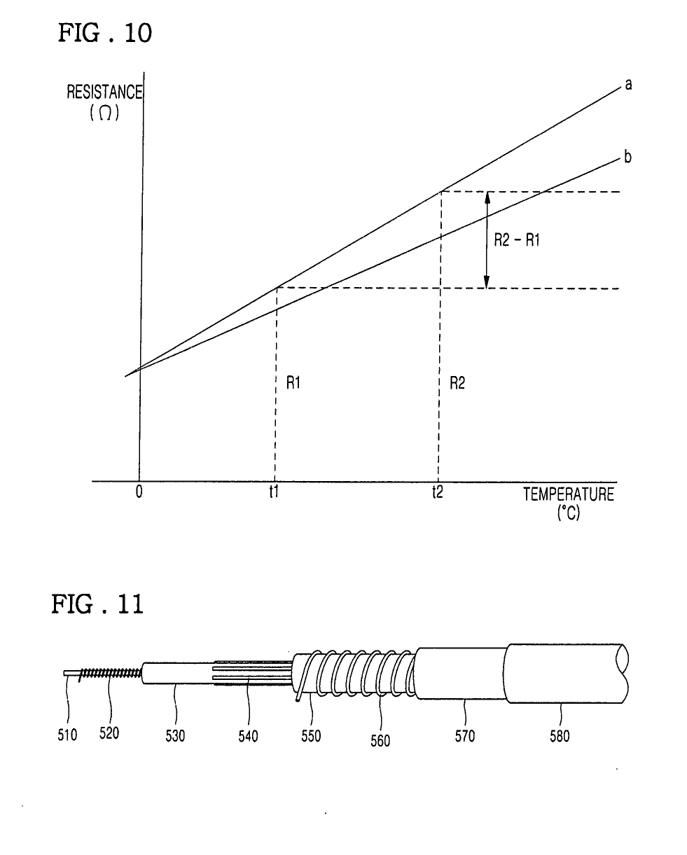

FIG. 10 is a graph comparing a change in temperature and resistance of the electromagnetic-field-shielded heating wires used in bedding illustrated in FIGS. 1 through 3 with a change in temperature and resistance of the electromagnetic-field-shielded heating wire used in bedding illustrated in FIGS. 6 through 9. As shown in FIG. 10, electromagnetic-field-shielded heating wires b used in bedding illustrated in FIGS. 6 through 9 have a more smooth width of a change (inclination) in resistance according to temperature than electromagnetic-field-shielded heating wires a used in bedding illustrated in FIGS. 1 through 3. Thus, in the electromagnetic-field-shielded heating wires used in bedding illustrated in FIGS. 6 through 9 compared to the electromagnetic-field-shielded heating wires used in bedding illustrated in FIGS. 1 through 3, as heat rises, the larger amount of energy consumed is reduced.

FIG. 11 illustrates the structure of an electromagnetic-field-shielded heating wire used in bedding according to another embodiment of the present invention.

As illustrated in FIG. 11, an electromagnetic-field-shielded heating wire used in bedding according to another embodiment of the present invention includes a core wire 510 that is formed of thread, a heater wire 520 that is formed of a pure iron wire wound on an outer circumferential surface of the core wire 510, an insulating inner coating 530 that is formed of nylon, Teflon or silicon coated to encompass the heater wire 520 including the core wire 510, a thread coating 540 that is formed on an outer circumferential surface of the insulating inner coating 530 to obtain a predetermined space, an insulating paper 550 that is coated on the outer circumferential surface of the insulating inner coating 530 including the thread coating 540, a ground wire 560 that is formed of a copper wire, for example, and wound on an outer circumferential surface of the insulating paper 550, a metallic thin film 570 that is formed of an aluminum thin film and a silver paper coated on the outer circumferential surface of the insulating paper 550 including the ground wire 560, and an insulating outer coating 580 that is formed of PVC, silicon or Teflon formed on an outer circumferential surface of the metallic thin film 570.

Here, the thread coating 540 allows a plurality of threads to be coated on the heating wire parallel to the lengthwise direction of the heating wire to obtain a space between threads so that heated air flows freely. Rayon yarn that is heat resistant yarn or glass yarn is appropriate to threads used in the thread coating 540. In addition, the thread coating 540 is formed to have a mesh shape and thus may coat the outer circumferential surface of the insulating inner coating 530 or one thread may be wound to encompass the outer circumferential surface of the insulating inner coating 530. In addition, the pure iron wire may have purity of 99.9% or higher.

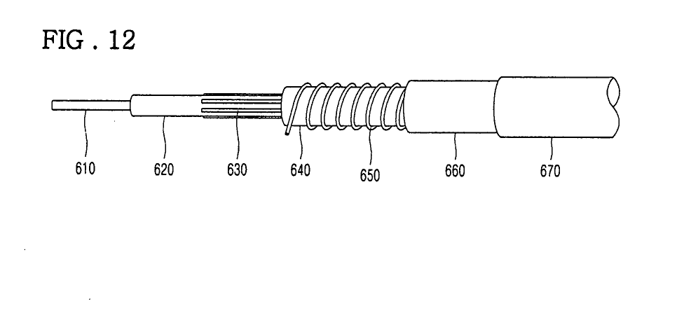

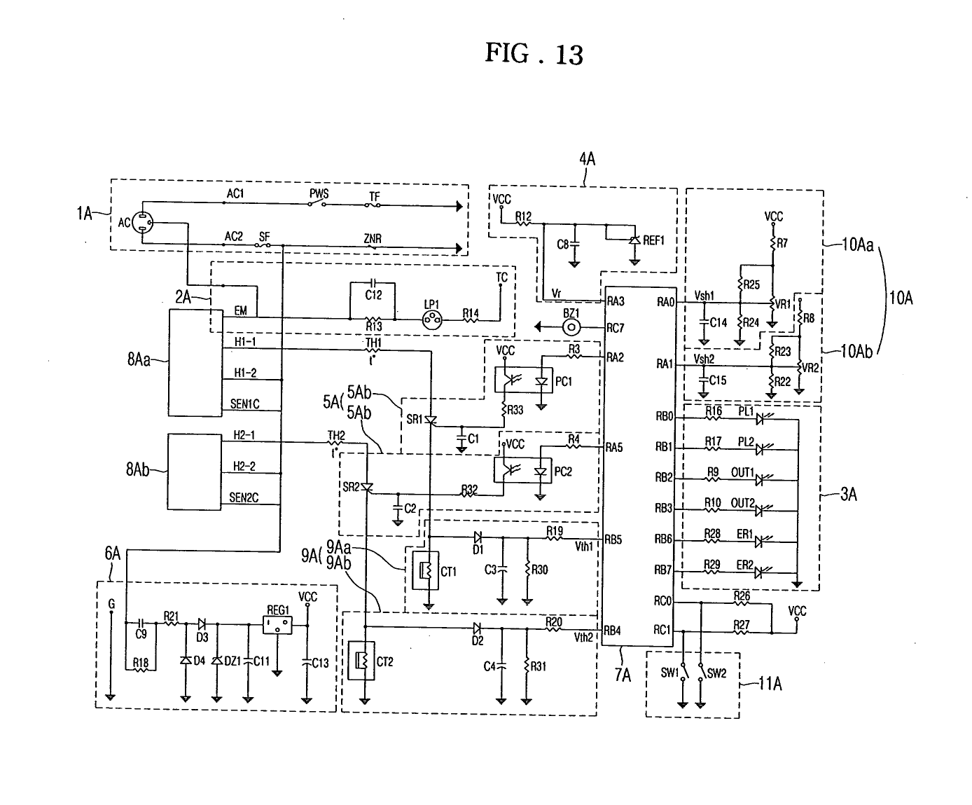

FIG. 12 illustrates the structure of an electromagnetic-field-shielded heating wire used in bedding according to another embodiment of the present invention.

As illustrated in FIG. 12, an electromagnetic-field-shielded heating wire used in bedding according to another embodiment of the present invention includes a heater wire that functions as a core wire and is formed of a pure iron wire for generating heat, an insulating inner coating 620 that is formed of nylon, Teflon or silicon coated on an outer circumferential surface of the heater wire 610, a thread coating 630 that is formed on an outer circumferential surface of the insulating inner coating 620 to obtain a predetermined space, an insulating paper 640 that is coated on the outer circumferential surface of the heater wire 610 including the thread coating 630, a ground wire 650 that is formed of a copper wire, for example, and wound on an outer circumferential surface of the insulating paper 640, a metallic thin film 660 that is formed of an aluminum thin film and a silver paper coated on the outer circumferential surface of the insulating paper 640 including the ground wire 650, and an insulating outer coating 670 that is formed of PVC, silicon or Teflon formed on an outer circumferential surface of the metallic thin film 660.

Here, the thread coating 630 allows a plurality of threads to be coated on the heating wire parallel to the lengthwise direction of the heating wire to obtain a space between threads so that heated air flows freely. Rayon yarn that is heat resistant yarn or glass yarn is appropriate to threads used in the thread coating 630. In addition, the thread coating 630 is formed to have a mesh shape and thus may coat the outer circumferential surface of the insulating inner coating 620 or one thread may be wound to encompass the outer circumferential surface of the insulating inner coating 630. In addition, the pure iron wire may have purity of 99.9% or higher.

An apparatus for driving the electromagnetic-field-shielded heating wires used in bedding illustrated in FIGS. 1 through 12, according to exemplary embodiments of the present invention will now be described.

FIG. 13 illustrates an apparatus for driving an electromagnetic-field-shielded heating wire used in bedding, according to an embodiment of the present invention.

As illustrated in FIG. 13, the apparatus for driving an electromagnetic-field-shielded heating wire used in bedding, according to an embodiment of the present invention includes first and second electromagnetic-field-shielded heating wires 8Aa and 8Ab, a safety circuit 1A, an electromagnetic wave sensing circuit 2A, a constant-voltage circuit 6A, first and second heating wire driving units 5Aa and 5Ab, first and second shunt voltage detecting circuits 9Aa and 9Ab, first and second heat setting circuits 10Aa and 10Ab, a selector 11A, a reference voltage generating circuit 4A, a display unit 3A, a buzzer BZ1, and a controller 7A.

If power is supplied to the first and second electromagnetic-field-shielded heating wires 8Aa and 8Ab, the first and second electromagnetic-field-shielded heating wires 8Aa and 8Ab generate heat and have the same construction as those of the electromagnetic-field-shielded heating wires illustrated in FIGS. 1 and 2, FIGS. 6 through 9, and FIGS. 11 and 12.

The safety circuit 1A includes a power switch PWS, fuses SF and TF, and a surge protector ZNR and operates to be automatically cut off if an overvoltage is generated in commercial power.

The electromagnetic wave sensing circuit 2A includes a touch terminal TC, a capacitor C12, resistors R13 and R14, and a lamp LP1. As the touch terminal TC is touched by a user, it is sensed whether an electromagnetic wave is generated in the electromagnetic-field-shielded heating wires 8Aa and 8Ab. If the electromagnetic wave is sensed, the lamp LP1 emits light.

The constant-voltage circuit 6A includes capacitors C9, C11 and C13, a resistor R21, diodes D3 and D4, a zenor diode ZD1, and a regulator REG. The constant-voltage circuit 6A rectifies and smoothens an alternating current (AC) to supply a direct current (DC) to each unit.

The first heating wire driving unit 5Aa includes resistors R3 and R33, a photocoupler PC1, a capacitor C1, and a thyristor SR1, and supplies commercial power to the first electromagnetic-field-shielded heating wire 8Aa.

The second heating wire driving unit 5Ab includes resistors R4 and R32, a photocoupler PC2, a capacitor C2, and a thyristor SR2 and supplies commercial power to the second electromagnetic-field-shielded heating wire 8Ab.

The first shunt voltage detecting circuit 9Aa includes an overcurrent preventing unit TH1, a current detector CT1, a diode D1, a capacitor C3, resistors R19 and R30, and detects a shunt voltage of the first electromagnetic-field-shielded heating wire 8Aa.

The second shunt voltage detecting circuit 9Ab includes an overcurrent preventing unit TH2, a current detector CT2, a diode D2, a capacitor C4 and resistors R20 and R31, and detects a shunt voltage of the second electromagnetic-field-shielded heating wire 8Ab.

The first heat setting circuit 10Aa includes resistors R7, R24 and R25, a variable resistor VR1 and a capacitor C14, and sets heating of the first electromagnetic-field-shielded heating wire 8Aa.

The second heat setting circuit 10Ab includes resistors R8, R22 and R23, a variable resistor VR2 and a capacitor C15, and sets heating of the second electromagnetic-field-shielded heating wire 8Ab.

The selector 11A includes first and second switches SW1 and SW2 and selects driving of the first and second electromagnetic-field-shielded heating wires 8Aa and 8Ab.

The reference voltage generating circuit 4A includes a resistor R12, a capacitor C8 and a reference voltage unit REF1.

The display unit 3A includes power display lamps PL1 and PL2, power supply display lamps OUT1 and OUT2, and error display lamps ER1 and ER2, displays that the first and second switches SW1 and SW2 are turned on (PL1, PL2), displays that power is supplied to the first and second electromagnetic-field-shielded heating wires 8Aa and 8Ab (OUT1, OUT2), and displays that errors occur in the first and second electromagnetic-field-shielded heating wires 8Aa and 8Ab (ER1, ER2).

The buzzer BZ1 generates a buzzer sound if errors occur in the first or second electromagnetic-field-shielded heating wire 8Aa or 8Ab.

If the first or second switch SW1 or SW2 is turned on, the controller 7A applies a control signal to the first or second heating wire driving unit 5Aa or 5Ab so as to drive the first or second electromagnetic-field-shielded heating wire 8Aa or 8Ab, detects current caused by heating of the first and second electromagnetic-field-shielded heating wires 8Aa and 8Ab through the first and second shunt voltage detecting circuits 9Aa and 9Ab, if the detected current is more than a value that is set by the first and second heat setting circuits 10Aa and 10Ab, the controller 7A controls the apparatus for driving an electromagnetic-field-shielded heating wire used in bedding to continuously supply power to the first and second electromagnetic-field-shielded heating wires 8Aa and 8Ab, if the detected current is less than the set values, the controller 7A controls the apparatus for driving an electromagnetic-field-shielded heating wire used in bedding to cut off power supplied to the first and second electromagnetic-field-shielded heating wires 8Aa and 8Ab, if it is sensed through the first and second shunt voltage detecting circuits 9Aa and 9Ab that a heater wire (pure iron wire) or core wire of the first and second electromagnetic-field-shielded heating wires 8Aa and 8Ab is shorted and an abnormal voltage is generated, the controller 7A controls the apparatus for driving an electromagnetic-field-shielded heating wire used in bedding to cut off power supplied to the first and second electromagnetic-field-shielded heating wires 8Aa and 8Ab and to display the buzzer BZ1 and the error display lamps ER1 and ER2 of the display unit 3A.

The operation of the apparatus for driving an electromagnetic-field-shielded heating wire used in bedding having the above structure according to the present embodiment will now be described.

In FIG. 13, two electromagnetic-field-shielded heating wires are connected to each other and heating of the electromagnetic-field-shielded heating wires can be independently controlled. However, the present invention does not use two electromagnetic-field-shielded heating wires but uses one electromagnetic-field-shielded heating wire and may constitute only one each driving unit for driving the electromagnetic-field-shielded heating wire.

First, for example, the operation of connecting the electromagnetic-field-shielded heating wire illustrated in FIG. 1 to the driving apparatus will now be described.

The core wire 110 and the heater wire 130 that are disposed at one end of the electromagnetic-field-shielded heating wire, are connected to terminals H1-1 and H1-2 or terminals H2-1 and H2-2 of the driving apparatus of FIG. 13, and the core wire 110 and the heater wire 130 that are disposed at the other end of the electromagnetic-field-shielded heating wire, are connected to each other. The ground wire 159 and the metallic thin film 160 of the electromagnetic-field-shielded heating wire are connected to an EM terminal of the electromagnetic wave sensing circuit 2A.

Thus, if an outlet is inserted in corner power AC 220V and the power switch PWS is turned on, the commercial power is rectified and smoothened at the constant-voltage circuit 6A so that a constant voltage which is a DC voltage can be supplied to each unit

If the user selects the first or second switch SW1 or SW2 using the selector 11A, power is supplied to the selected electromagnetic-field-shielded heating wires 8Aa and 8Ab. In details, if the first switch SW1 is turned on, power is supplied to the first electromagnetic-field-shielded heating wire 8Aa and the first electromagnetic-field-shielded heating wire 8Aa is heated, and if the second switch SW2 is turned on, power is supplied to the second electromagnetic-field-shielded heating wire 8Ab and the second electromagnetic-field-shielded heating wire 8Ab is heated.

At this time, the controller 7A controls the driving apparatus to emit the power display lamps PL1 and PL2 of the display unit 3A to display that the first or second switch SW1 or SW2 is selected.

The user controls variable resistors VR1 and VR2 of the first heat setting circuit 10Aa or the second heat setting circuit 10Ab to set the heating temperature of the first or second electromagnetic-field-shielded heating wire 8Aa or 8Ab.

If the selector 11A and the first and second heat setting circuits 10Aa and 10Ab are selected by the user, the controller 7A controls the driving apparatus to output a control signal to the first and second heating wire driving units 5Aa and 5Ab to supply power to the first and second electromagnetic-field-shielded heating wires 8Aa and 8Ab so that the first and second electromagnetic-field-shielded heating wires 8Aa and 8Ab can be heated. In details, if a “high” signal is output to output terminals RA2 and RA5, the photocouplers PC1 and PC2 are turned on and the “high” signal is applied to a gate terminal of each thyristor SR1 or SR2 and thus, the thyristors SR1 and SR2 are turned on and the commercial power AC 220V is applied to each of the electromagnetic-field-shielded heating wires 8Aa and 8Ab.

At this time, if power is supplied to the first and second electromagnetic-field-shielded heating wires 8Aa and 8Ab, the controller 7A controls the driving apparatus to turn on and display a power supply display lamp of the display unit 3A, and if power is not supplied to the first and second electromagnetic-field-shielded heating wires 8Aa and 8Ab, the controller 7A controls the driving apparatus to turn off the power supply display lamp of the display unit 3A.

If the commercial power is applied to the first and second electromagnetic-field-shielded heating wires 8Aa and 8Ab in this way, heat is generated in the first and second electromagnetic-field-shielded heating wires 8Aa and 8Ab. If heat rises, the resistance of the heater wire 130 formed of a pure iron wire is increased at a predetermined inclination, as illustrated in FIGS. 4 and 5.

Thus, if the heater wire 130 is heated and the resistance is increased, a low current is detected by the current detectors CT1 and CT2 of the first and second shunt voltage detecting circuits 9Aa and 9Ab, and the detected current is changed into a voltage by the first and second shunt voltage detecting circuits 9Aa and 9Ab, and the voltage is inputted to the controller 7A.

The voltage that is outputted from the first and second shunt voltage detecting circuits 9Aa and 9Ab in this way is compared with the value that is set by the first and second heat setting circuits 10Aa and 10Ab. A control signal (high/low) is outputted to the output terminals RA2 and RA5 to approach the set value so that power applied to the first and second electromagnetic-field-shielded heating wires 8Aa and 8Ab is turned on/off in response to the control signal.

In addition, if the heater wire 130 and the core wire 110 of the first and second electromagnetic-field-shielded heating wires 8Aa and 8Ab are shorted, the resistance of the heater wire 130 is relatively, rapidly reduced so that a high voltage is detected by the first and second shunt voltage detecting circuits 9Aa and 9Ab, and if the heater wire 130 or the core wire 110 is opened, any voltage will not be detected even when power is supplied to the first and second electromagnetic-field-shielded heating wires 8Aa and 8Ab.

If any voltage is detected or is not detected by the first and second shunt voltage detecting circuits 9Aa and 9Ab to be more than an arbitrary set value, the controller 7A determines that an error such as short or open occurs in the first and second electromagnetic-field-shielded heating wires 8Aa and 8Ab to cut off power supplied to the first and second electromagnetic-field-shielded heating wires 8Aa and 8Ab, to turn on the buzzer BZ1 and the error display lamps ER1 and ER2 of the display unit 3A to display that an error occurs in bedding.

In addition, the controller 7A includes a timer at its inside. Thus, if the first or second switch SW1 or SW2 of the selector 11A is turned on for more than a predetermined time (10 hours), the controller 7A determines that the user has gone out in the state where the bedding is turned on and cuts off power supplied to the first and second electromagnetic-field-shielded heating wires 8Aa and 8Ab.

In addition, even when an electromagnetic field is generated in the first and second electromagnetic-field-shielded heating wires 8Aa and 8Ab, the electromagnetic field is shielded by the ground wire 150 and the metallic thin film 160. However, an induced current is generated in the ground wire 150 and the metallic thin film 160, and if the user touches the terminal TC of the electromagnetic wave sensing circuit 2A or is in contact with other materials, the lamp LP1 of the electromagnetic wave sensing circuit 2A emits light. Thus, even when an electromagnetic field including an electromagnetic wave is generated in the electromagnetic-field-shielded heating wires, the electromagnetic field is shielded not to affect the human body but generation of the electromagnetic field may be notified to the user.

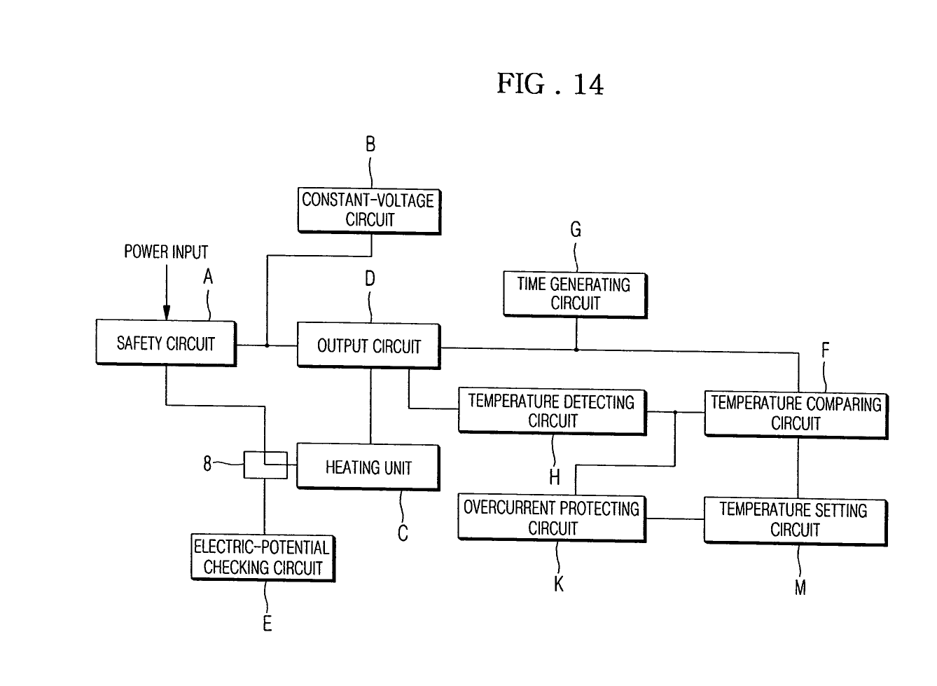

FIG. 14 is a block diagram illustrating an apparatus for driving an electromagnetic-field-shielded heating wire used in bedding, according to another embodiment of the present invention.

As illustrated in FIG. 14, the apparatus for driving electromagnetic-field-shielded heating wire used in bedding according to the present invention includes a heating unit C, a safety circuit A, an electric-potential checking circuit E, a constant-voltage circuit B, an output circuit D, a temperature setting circuit M, a temperature detecting circuit H, an overcurrent protecting circuit K, a temperature comparing circuit F, and a time generating circuit G.

The heating unit C includes a heater wire formed of a pure iron wire, and if commercial power is supplied to the heating unit C, the heating unit C generates heat, and as temperature rises, the resistance of the heater wire is increased. The heating unit C includes the electromagnetic-field-shielded heating wires used in FIGS. 1 and 2, FIGS. 6 through 9, and FIGS. 11 and 12.

The safety circuit A cuts off power supply automatically if an overvoltage is generated in the commercial power supplied to the heating unit C. The electric-potential checking circuit E checks that an electromagnetic wave is generated in the heating unit C.

The constant-voltage circuit B rectifies and smoothens the commercial power supplied to the heating unit C to supply a DC to each unit. The output circuit D controls the supply of the commercial power supplied to the heating unit C. The temperature setting circuit M sets the heating temperature of the heating unit C. The temperature detecting circuit H detects the temperature of the heating unit C.

If an overcurrent is generated in the heating unit C, the overcurrent protecting circuit K outputs a control signal to the temperature setting circuit M so that power cannot be supplied to the heating unit C regardless of the set value of the temperature setting circuit M.

The temperature comparing circuit F compares a voltage caused by temperature setting of the temperature setting circuit M with a voltage caused by temperature detecting of the temperature detecting circuit H, if the voltage of the temperature detecting circuit H is higher than the voltage of the temperature setting circuit M, the temperature comparing circuit F outputs a control signal so that the output circuit D can output the commercial power to the heating unit C, and if the voltage of the temperature detecting circuit H is lower than the voltage of the temperature setting circuit M, the temperature comparing circuit F outputs a control signal so that the commercial power cannot be supplied to the heating unit C.

The time generating circuit G outputs a pulse signal having an arbitrary duty ratio, and if the temperature comparing circuit F outputs a control signal so that the commercial power cannot be supplied to the heating unit C, the time generating circuit G controls the driving apparatus to supply the commercial power to the heating unit C for a short time so as to detect temperature. Here, unexplained reference numeral 8 denotes an electric-potential checking guide wire.

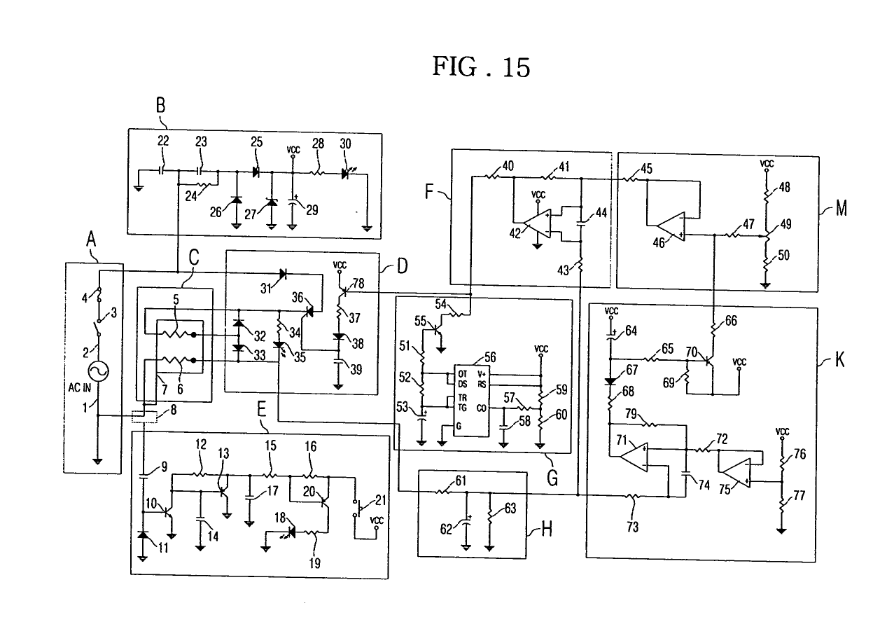

FIG. 15 is a detailed circuit diagram illustrating an example of the apparatus for driving an electromagnetic-field-shielded heating wire used in bedding illustrated in FIG. 14.

The operation of an example of the apparatus for driving an electromagnetic-field-shielded heating wire used in bedding illustrated in FIG. 14 will now be described with reference to FIG. 15.

The heating unit C includes an electromagnetic-field-shielded heating wire comprising a core wire 6, a heater wire 5 formed of a pure iron wire, and a ground wire (shield wire) 7, as illustrated in FIGS. 1 and 2, FIGS. 6 through 9, and FIGS. 11 and 12, and if the temperature of the heating wire increases, the resistance of the heating wire is increase, and a voltage flowing through the heating wire is reduced.

The safety circuit A includes a power switch 3 and a fuse 4. If the power switch 3 is turned on, the safety circuit A supplies commercial power to the heating unit C, and if an overvoltage is generated in the commercial power, the fuse 4 is cut and the commercial power is automatically cut off.

The constant-voltage circuit B includes limit condensers 22 and 23, limit resistors 24 and 28, composite rectifier diodes 25 and 26, a zenor diode 27, a smoothing condenser 29, and a power display lamp 30, and rectifies and smoothens the commercial power to supply the DC to each unit, and the power display lamp 30 emits light so that the commercial power can be supplied to the heating unit C.

The electric-potential checking circuit E includes an electric-potential checking guide wire 8, amplification transistors 10, 13 and 20, a condenser 9, bias condensers 14 and 17, a bias diode 11, limit resistors 12, 15 and 19, a bias resistor 16, an electric-potential lamp 18, and an electric-potential button 21, and if an electromagnetic field or a magnetic field is generated in the heating unit C and a harmful electromagnetic wave is generated, noise occurs in the shield wire 7 of the heating unit C and the electric-potential checking guide wire 8, the noise is amplified through the condensers 9, 14 and 17, the amplification transistors 10 and 13, and the resistor 12, and if the electric-potential checking button 21 is touched, the electric-potential checking lamp 18 is driven and emits light so that the electric potential can be checked. At this time, the location of the commercial power plug of the safety circuit A is changed and a terminal 1 is grounded with the earth, noise caused by generation of an electromagnetic wave is not sensed, and simultaneously, the ground wire (shield wire) 7 of the heating unit C is grounded with the earth so that the electromagnetic wave is not generated and induced noise is not generated in the electro-potential checking guide wire 8 of the electric-potential checking circuit E. Thus, amplification of the electric-potential checking circuit E is stopped and the electric-potential checking lamp 18 is turned off so that the user can use bedding in which an electromagnetic wave is not generated. Here, the electric-potential checking guide wire 8 is installed near the shield wire (ground wire) 7 and is wound on the shield wire (ground wire) 7.

The temperature detecting circuit H includes a limit resistor 61, a partial pressure resistor 63, and a bias condenser 62, detects the temperature of the heating unit C, and outputs a voltage caused by the detected temperature. In details, if temperature is low, a high voltage is outputted, and if temperature is high, a lower voltage is outputted.

The temperature setting circuit M includes partial pressure resistors 48 and 50, a temperature setting variable resistor 49, limit resistors 45 and 47, and a voltage compensator 46 for compensating a voltage, changes the resistance of the temperature setting variable resistor 49 to set temperature, and outputs a voltage caused by the set temperature.

The overcurrent protecting circuit K includes composite partial pressure resistors 76 and 77, a voltage compensator 75, limit resistors 65, 66, 68, 72 and 73, bias resistors 69 and 79, a delay condenser 64, a bias condenser 74, a detection diode 67, a driving transistor 70, and an overcurrent unit 71, senses that an overcurrent is generated in the heating unit C through the temperature detecting circuit H, and outputs a high signal to the temperature setting circuit M. Thus, power supplied to the heating unit C is cut off regardless of the temperature set resistance of the temperature setting circuit M.

The temperature comparing circuit F includes limit resistors 40 and 43, a hysteresis resistor 41, a temperature comparator 42, and a noise eliminating condenser 44, compares a signal outputted from the temperature setting circuit M and a signal outputted from the temperature detecting circuit H, and outputs a control signal to the output circuit D according to the comparison result.

In details, if a voltage outputted from the temperature detecting circuit H is higher than a voltage outputted from the temperature setting circuit M, the temperature comparing circuit F outputs a control signal to the output circuit D so that the commercial power can be supplied to the heating unit C, and if the voltage outputted from the temperature detecting circuit H is lower than the voltage outputted from the temperature setting circuit M, the temperature comparing circuit F outputs a control signal to the output circuit D so that the commercial power cannot be supplied to the heating unit C.

The time generating circuit G includes a time generator 56, partial pressure resistors 59 and 60, a bias resistor 57, a bias condenser 58, a time partial pressure resistor 52, a time partial pressure condenser 53, limit resistors 51 and 54, and a pulse driving transistor 55. The time generator 56 outputs a uniform pulse signal, and the pulse driving transistor 55 connects an output terminal of the temperature comparing circuit F to a ground terminal or cuts off connection thereof. Here, an integrated circuit LM555 is appropriate to the time generator 56.

The output circuit D includes a plurality of diodes 31, 32, 33 and 38, a transistor 78, limit resistors 34 and 37, a bias condenser 39, a thyristor 36 for output control, and an output display lamp 35, switches the commercial power supplied to the heating unit C according to a control signal outputted from the temperature comparing circuit F, and supplies the commercial power to the heating unit C instantaneously by the time generating circuit G.

In details, the commercial power is supplied to the heating unit C by an interlocking of the transistor 78 and the thyristor 36 for output control. At this time, the first diode 31 connects a space between the terminal 2 of the safety circuit A and the heater wire 5 of the heating unit C in a forward direction by using the thyristor 36 for output control, the second diode 33 connects a space between the heater wire 5 and the core wire 6 of the heating unit C in a forward direction, and the third diode 32 prevents reverse discharge.

In other words, one end of the heater wire 5 of the heating unit C is connected to the terminal 2 of commercial power (plug) through the first diode 31 and the thyristor 36 for output control, and one end of the core wire 6 is connected to the terminal 1 of commercial power (plug). The other end of the heater wire 5 is connected to the other end of the core wire 6 through the second diode 33, and the ground wire (shield wire) 7 is also connected to the terminal 1 of the commercial power (plug) together with a heater wire.

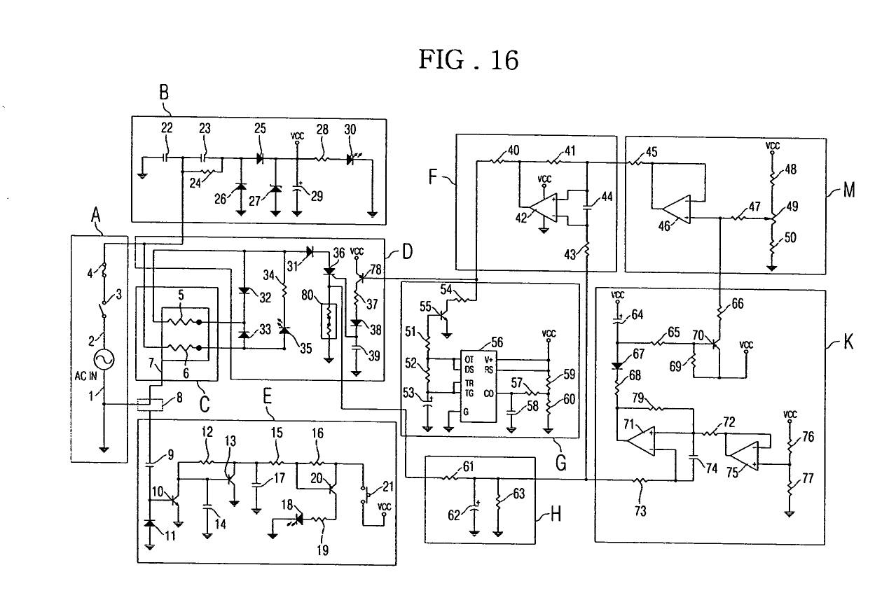

FIG. 16 is a detailed circuit diagram illustrating another example of the apparatus for driving an electromagnetic-field-shielded heating wire used in bedding illustrated in FIG. 14.

The operation of another example of the apparatus for driving an electromagnetic-field-shielded heating wire used in bedding illustrated in FIG. 14 will now be described with reference to FIG. 16.

In the apparatus for driving an electromagnetic-field-shielded heating wire used in bedding illustrated in FIG. 16, according to another example of FIG. 14, other elements excluding an output circuit are the same as those of FIG. 15 and thus, a description thereof will be omitted and only the output circuit will now be described.

In the construction of the output circuit D of FIG. 15, there is a possibility that a peak voltage may occur when the thyristor 36 on/off operates, and as such, there is a possibility that elements of the driving apparatus may be destroyed. Thus, in order to prevent this, the apparatus for driving an electromagnetic-field-shielded heating wire used in bedding, according to the present example allows the commercial power to sequentially flow through the core wire 6 of the heating unit C, the diode 33 of the output circuit D, the heater wire 5 of the heating unit C, the thyristor 36, and the diode 31, as illustrated in FIG. 16, and a wire wound resistor 80 is additionally installed between the thyristor 36 and a ground terminal.

The wire wound resistor 80 is a resistor without reactance and includes two wound wires.

An operation of the apparatus for driving an electromagnetic-field-shielded heating wire used in bedding having the above structure according to the present invention will now be described.

A power plug is inserted in a commercial power plug and the power switch 3 of the safety circuit A is turned on, commercial power AC 220V is supplied to the constant-voltage circuit B and the output circuit D.

The constant-voltage circuit B rectifies and smoothens the commercial power to supply a DC to each unit. At this time, the power display lamp 30 of the constant-voltage circuit unit B emits light to display that the commercial power is supplied to the apparatus for driving an electromagnetic-field-shielded heating wire used in bedding.

In addition, since the commercial power flows through the diode 31 of the output circuit D, the thyristor 36, the heater wire 5 of the heating unit C, the diode 33, and the core wire 6, the heating unit C is heated.

If the heating unit C is heated in this way, turn-on and turn-off of the output display lamp 35 of the output circuit D is repeatedly performed and the output display lamp 35 displays that the heating unit C is being heated. The diode 32 of the output circuit D prevents reverse discharge.

At this time if the heating unit C is heated, heat of the heater wire 5 formed of a pure iron wire rises and the temperature of the heating unit C (heating wire) is in proportion to the resistance of the heating wire so that a voltage flowing through the heating wire is inversely proportional to temperature.

In details, since the temperature of the heating unit C is low at an initial stage, the heating wire of the heating unit C has a low resistance and the voltage flowing through the heating wire is high. If time elapses and the temperature of the heating unit C rises, the resistance of the heating unit C becomes larger and the voltage flowing through the heating unit C is lowered.

The temperature detecting circuit H detects a voltage supplied to the heating unit C from a cathode of the diode 33 of the output circuit D to supply the voltage to an inverse terminal (−) of the overcurrent comparator 71 of the overcurrent protecting circuit K and an inverse terminal (−) of the temperature comparator 42 of the temperature comparing circuit F.

As described above, at an initial stage, the voltage detected by the temperature detecting circuit H is high and as temperature rises, the detected voltage is lowered.

In response to the DC power supplied from the constant-voltage circuit E, the time generating circuit G operates by the DC power supplied from the constant-voltage circuit E and a pulse signal having a proper duty ratio (the ratio of off time to on time) is outputted from the time generator 56, the pulse driving transistor 55 repeatedly performs on/off.

At this time, the duty ratio of the time generator 56 may be adjusted by the bias resistor 57 and the bypass condenser 58, and in the present invention, on time has a relatively very short duty ratio than in off time. For example, a pulse signal having the duty ratio of on time of 3 seconds and off time of 30 seconds is outputted.

In addition, the user adjusts the temperature setting variable resistor 49 of the temperature setting circuit M to set a desired temperature, and the voltage compensator 46 outputs a predetermined voltage to a non-inverse terminal (+) of the temperature comparator 42 of the temperature comparing circuit F according to the resistance of the temperature setting variable resistor 49. At this time, the voltage outputted from the temperature setting circuit M is set to be lower than the voltage outputted from the temperature detecting circuit H at an initial stage.

If the voltage outputted from the temperature detecting circuit H is higher than the voltage set by the temperature setting circuit M, the time comparator 42 of the temperature comparing circuit F outputs a “low” signal, and if the voltage outputted from the temperature detecting circuit H is lower than the voltage outputted from the temperature setting circuit M, the time comparator 42 of the temperature comparing circuit F outputs a “high” signal.

However, since the voltage outputted from the temperature detecting circuit H is higher than the voltage outputted from the temperature setting circuit M at an initial stage, the temperature comparator 42 of the temperature comparing circuit F outputs a “low” signal. Thus, if the “low” signal is outputted from the temperature comparator 42 of the temperature comparing circuit F, the transistor 78 of the output circuit D is turned on and a high signal is applied to a gate terminal of the thyristor 36. Since the thyristor 36 is turned on, the commercial power is continuously applied to the heating unit C, as described above.

At this time, even when the pulse driving transistor 55 of the time generating circuit G is turned on/off by the above-described duty ratio, regardless of this, the output signal that is applied to the gate terminal of the transistor 78 of the output circuit D from the temperature comparator 42 of the temperature comparing circuit F is continuously kept at the “low” signal.

If the commercial power is continuously supplied to the heating unit C by the output circuit D in this way and the heating wire of the heating unit C is heated to over the temperature set by the temperature setting circuit M, the voltage outputted from the temperature detecting circuit H becomes lower than the voltage set by the temperature setting circuit M so that the temperature comparator 42 of the temperature comparing circuit F outputs a “high” signal.

At this time, the pulse driving transistor 55 of the time generating circuit G is turned on for 3 seconds and is turned off for 30 seconds in response to the pulse signal having the above-described duty ratio. Thus, the “high” signal outputted from the temperature comparator 42 of the time comparing circuit F is kept at the “low” signal for 3 seconds and at the “high” signal for 30 seconds by an on/off operation of the pulse driving transistor 55 of the time generating circuit G.

This is because, when the pulse driving transistor 55 is turned on, the output terminal of the temperature comparator 42 of the temperature comparing circuit F is connected to the ground terminal and when the pulse driving transistor 55 is turned off, the output terminal of the temperature comparator 42 of the temperature comparing circuit F is not connected to the ground terminal.

In this way, even when the temperature comparator 42 of the temperature comparing circuit F does not output the “high” signal, the transistor 78 of the output circuit D performs an on operation for 3 seconds and an off operation for 30 seconds by the time generating circuit G.

If the transistor 78 of the output circuit D performs the on operation for 3 seconds and the off operation for 30 seconds in this way, the heating unit C is not heated by the commercial power but the commercial power is supplied to the heating unit C for 3 seconds. Thus, at this time, the temperature detecting circuit H detects temperature and outputs a voltage corresponding to the detected temperature.

Thus, the temperature comparator 42 of the temperature comparing circuit F compares the voltage set by the temperature setting circuit M with the voltage outputted from the temperature detecting circuit H to control the temperature of the heating unit C automatically.

If an overcurrent is generated in the temperature detecting circuit H by short of the heating unit C, since the driving transistor 70 is turned on, the overcurrent protecting circuit K applies a “high” signal to the voltage compensator 46 of the temperature setting circuit M.

If the “high” signal is applied to the voltage compensator 46 of the temperature setting circuit M, a high level is applied to a base of the transistor 78 of the output circuit D and the commercial power is not supplied to the heating unit C.

In addition, if an electromagnetic wave is generated in the heating wire of the heating unit C, i.e., if noise occurs in the terminal 1 of the safety circuit A, the noise is amplified by the amplification transistors 10 and 13 of the electric-potential checking circuit E. If the user touches the electric-potential checking button 21 of the electric-potential checking circuit E, the electric-potential checking lamp 18 is turned on and displays that the electromagnetic wave is generated in the heating unit C.

At this time, if the power plug is inserted in the outlet by changing its location, the terminal 1 of the safety circuit A is grounded with the earth and noise is not sensed. And, since the terminal 1 of the safety circuit A and the shield wire 7 of the heating unit C are grounded with the earth, the electromagnetic wave is not generated in the heating unit C and an induced noise is not generated in the electro-potential checking guide wire 8 of the electric-potential checking circuit E and thus, the electric-potential checking lamp 18 is turned on and displays that the electromagnetic wave is not generated in the heating unit.

In the embodiments illustrated in FIGS. 11 and 12, the thread coating is formed between the insulating inner coating and the insulating paper but the present invention is not limited to this and the thread coating may also be formed between the heater wire and the insulating inner coating.

As described above, the present invention has the following effects.

First, in the electromagnetic-field-shielded heating wire used in bedding according to the present invention, since the heater wire is formed of pure iron having a uniform change in resistance according to temperature, temperature can be precisely controlled without using an additional temperature sensing wire, and since the pure iron has a relatively small width of a change in resistance according to temperature (inclination is smooth), as heat rises, the amount of energy consumed can be reduced.

Second, in the electromagnetic-field-shielded heating wire used in bedding according to the present invention, since the ground wire and the metallic thin film are coated on an outer circumference of the heater wire formed of pure iron, an electromagnetic field can be shielded. In addition, since the ground wire and the metallic thin film are coated on the outer circumference of the heater wire formed of pure iron and the ground wire is indirectly grounded with the earth, an induced current is not generated in the heating wire and the electromagnetic field can be shielded.

Third, in the electromagnetic-field-shielded heating wire used in bedding according to the present invention, since both the insulating coating such as nylon and the insulating paper are coated between the core wire and the heater wire and between the heater wire and the ground wire and the shield wire, the insulating property therebetween is improved and a short defect is prevented from occurring in the heating wire even at a high temperature.

Fourth, in the electromagnetic-field-shielded heating wire used in bedding according to the present invention, since the thread coating is formed to obtain a space in which the air heated by the heater wire flows freely, a uniform heating effect on the entire heating wire can be obtained and a uniform heating effect on the whole bedding can also be obtained.

Fifth, in the apparatus for driving an electromagnetic-field-shielded heating wire used in bedding according to the present invention, since, even when temperature is detected from the entire heating wire and short occurs in any location of the entire area of the heating wire, if power is abnormally supplied like that an overcurrent is supplied to the heating wire, the power is immediately cut off, overheat and fire and an electric shock accident can be prevented in advance from occurring and the bedding can be more safely used.

Sixth, in the apparatus for driving an electromagnetic-field-shielded heating wire used in bedding according the present invention, since, even when an additional temperature sensor is not used, overheat or short between the heating wires is determined and it is determined whether a heated current will be properly supplied to the heating wire using the set overcurrent protecting circuit, temperature can be controlled only with a simple construction and the bedding can be more safely used.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electromagnetic-field-shielded heating wire used in bedding, the heating wire comprising:
a core wire which is formed of a copper or enamel wire;
a first insulating inner coating which is coated on an outer surface of the core wire to encompass an outer circumferential surface of the core wire;
a heater wire which is wound on an outer circumferential surface of the first insulating inner coating;
a second insulating inner coating which is coated on an outer surface of the first insulating inner coating to encompass the outer circumferential surface of the first insulating inner coating including the heater wire;
a ground wire which is formed on an outer circumferential surface of the second insulating inner coating; and
a metallic thin film which is coated on the outer circumferential surface of the second insulating inner coating including the ground wire.

2. The heating wire of claim 1, wherein the ground wire is wound on the outer circumferential surface of the second insulating inner coating or is disposed to be long in a lengthwise direction of the outer circumferential surface of the second insulating inner coating.

3. The heating wire of claim 1, wherein the first and second insulating coatings is formed of a material selected from the group consisting of nylon, Teflon and silicon.

4. The heating wire of claim 1, wherein the metallic thin film is a silver foil film or an aluminum thin film.

5. The heating wire of claim 1, wherein the heater wire formed of pure iron (Fe) has a temperature sensing function.

6. The heating wire of claim 1, further comprising an insulating outer coating which is coated on an outer circumferential surface of the metallic thin film to encompass the metallic thin film.

7. The heating wire of claim 6, wherein the insulating outer coating is formed of PVC, silicon or Teflon.

8. An electromagnetic-field-shielded heating wire used in bedding, the heating wire comprising:
a core wire which is enamel-coated on a pure iron wire;
a first insulating coating which is coated on an outer surface of the core wire to encompass an outer circumferential surface of the core wire;
a heater wire which is wound on an outer circumferential surface of the first insulating coating and formed of an enamel-coated pure iron (Fe) wire;
a second insulating coating which is coated on the outer circumferential surface of the first insulating coating including the heater wire;
a ground wire which is formed on an outer circumferential surface of the second insulating coating; and
an insulating paper which is wound on the outer circumferential surface of the second insulating coating including the ground wire.

9. The heating wire of claim 8, wherein an insulating paper is further coated on the outer circumferential surface of the first insulating coating between the first insulating coating and the heater wire.

10. The heating wire of claim 8, wherein the ground wire is wound on the outer circumferential surface of the second insulating coating or is disposed to be long in a lengthwise direction of the second insulating coating on the outer circumferential surface of the second insulating coating.

11. The heating wire of claim 8, wherein the heater wire formed of an enamel-coated pure iron (Fe) wire has a temperature sensing function.

12. The heating wire of claim 8, wherein the first and second insulating coatings are formed of a material selected from the group consisting of nylon, Teflon and silicon.

13. An electromagnetic-field-shielded heating wire used in bedding, the heating wire comprising:
a core wire which is enamel-coated on a copper wire or pure iron wire;
an insulating inner coating which is coated on an outer surface of the core wire to encompass an outer circumferential surface of the core wire;
an insulating paper which is coated on an outer circumferential surface of the insulating inner coating;
a heater wire which is formed of pure iron (Fe) wound on an outer circumferential surface of the insulating paper; and
an insulating outer coating which is coated on the outer circumferential surface of the insulating paper including the heater wire.

14. The heating wire of claim 13, wherein the heater wire formed of an enamel-coated pure iron (Fe) wire has a temperature sensing function.

15. The heating wire of claim 13, wherein the insulating inner coating is formed of a material selected from the group consisting of nylon, Teflon and silicon.

16. An electromagnetic-field-shielded heating wire used in bedding, the heating wire comprising:
a core wire which is formed of a copper wire or pure iron wire;
a first insulating inner coating which is coated on an outer surface of the core wire to encompass an outer circumferential surface of the core wire;
a first insulating paper which is wound on an outer circumferential surface of the first insulating inner coating;
a heater wire which is formed of pure iron (Fe) wound on an outer circumferential surface of the first insulating paper;
a second insulating inner coating which is coated on an outer circumferential surface of the first insulating paper including the heater wire;
a second insulating paper which is coated on an outer circumferential surface of the second insulating inner coating;
a ground wire which is formed on an outer circumferential surface of the second insulating paper;
a metallic thin film which is coated on the outer circumferential surface of the second insulating paper including the ground wire; and
an insulating outer coating which is coated on an outer circumferential surface of the metallic thin film.

17. The heating wire of claim 16, wherein the heater wire formed of pure iron (Fe) has a temperature sensing function.

18. The heating wire of claim 16, wherein the first and second insulating inner coatings are formed of a material selected from the group consisting of nylon, Teflon and silicon,
the metallic thin film is formed of a silver foil film or an aluminum thin film, and
the insulating outer coating is formed of PVC, silicon or Teflon.

19. An electromagnetic-field-shielded heating wire used in bedding, the heating wire comprising:
a core wire which is formed of a copper wire or pure iron wire;
a first insulating inner coating which is coated on an outer surface of the core wire to encompass an outer circumferential surface of the core wire;
a first insulating paper which is wound on an outer circumferential surface of the first insulating inner coating;
a heater wire which is coated on an outer circumferential surface of the first insulating paper and is formed of pure iron (Fe);
a second insulating inner coating which is coated on an outer circumferential surface of the first insulating paper including the heater wire;
a second insulating paper which is coated on an outer circumferential surface of the second insulating inner coating;
a shield wire which is formed on an outer circumferential surface of the second insulating paper; and
an insulating outer coating which is formed on an outer circumferential surface of the heating wire including the shield wire.

20. The heating wire of claim 19, wherein the heater wire formed of pure iron (Fe) has a temperature sensing function.

21. The heating wire of claim 19, wherein the first and second insulating inner coatings are formed of a material selected from the group consisting of nylon, Teflon and silicon, and
the insulating outer coating is formed of PVC, silicon or Teflon.

22. An electromagnetic-field-shielded heating wire used in bedding, the heating wire comprising:
a core wire which is formed of thread;
a heater wire which is formed of a pure iron wire wound on an outer circumferential surface of the core wire;
an insulating inner coating which is coated to encompass the heater wire including the core wire;
an insulating paper which is coated on the outer circumferential surface of the insulating inner coating;
a ground wire which is formed on an outer circumferential surface of the insulating paper;
a metallic thin film which is coated on the outer circumferential surface of the insulating paper including the ground wire; and
an insulating outer coating which is formed on an outer circumferential surface of the metallic thin film.

23. The heating wire of claim 22, wherein the heater wire formed of pure iron (Fe) has a temperature sensing function.

24. The heating wire of claim 22, wherein at least one thread is disposed in a lengthwise direction of the heating wire, one thread is wound or a mesh-shaped thread coating is coated between the insulating inner coating and the insulating paper or between the heater wire and the insulating inner coating.

25. The heating wire of claim 22, wherein the insulating inner coating is formed of a material selected from the group consisting of nylon, Teflon and silicon,
the metallic thin film is formed of a silver foil film or an aluminum thin film, and
the insulating outer coating is formed of PVC, silicon or Teflon.

26. The heating wire of claim 24, wherein the thread is rayon yarn or glass yarn.

27. An electromagnetic-field-shielded heating wire used in bedding, the heating wire comprising:
a heater wire which functions as a core wire and is formed of pure iron;
an insulating inner coating which is coated on an outer circumferential surface of the heater wire;
an insulating paper which is coated on the outer circumferential surface of the insulating inner coating;
a ground wire which is formed on an outer circumferential surface of the insulating paper;
a metallic thin film which is coated on the outer circumferential surface of the insulating paper including the ground wire; and
an insulating outer coating which is formed on an outer circumferential surface of the metallic thin film.

28. The heating wire of claim 27, wherein the heater wire formed of pure iron (Fe) has a temperature sensing function.

29. The heating wire of claim 27, wherein at least one thread is disposed in a lengthwise direction of the heating wire, one thread is wound or a mesh-shaped thread coating is coated between the insulating inner coating and the insulating paper or between the heater wire and the insulating inner coating.

30. The heating wire of claim 27, wherein the insulating inner coating is formed of a material selected from the group consisting of nylon, Teflon and silicon,
the metallic thin film is formed of a silver foil film or an aluminum thin film, and
the insulating outer coating is formed of PVC, silicon or Teflon.

31. The heating wire of claim 29, wherein the thread is rayon yarn or glass yarn.

32. An apparatus for driving an electromagnetic-field-shielded heating wire used in bedding, the apparatus comprising:
an electromagnetic-field-shielded heating wire which includes a heater wire and generates heat if power is supplied to the heating wire;
a safety circuit which is automatically cut off if an overvoltage is generated in commercial power;
an electromagnetic wave sensing circuit which senses that an electromagnetic field is generated in the heating wire;
a constant-voltage circuit which rectifies and smoothens the commercial power to supply a DC (direct current) to each unit;
a heating wire driving unit which supplies the commercial power to the heating wire;
a shunt voltage detecting circuit which detects a shunt voltage of the heating wire;
a heat setting circuit which sets heating of the heating wire;
a display unit which displays that power is being supplied to the heating wire and displays that an error occurs in the heating wire; and
a controller which applies a control signal to the heating wire driving unit according to setting of the heat setting circuit and a current of the heating wire detected by the shunt voltage detecting circuit, controls the apparatus to compare the current of the heating wire detected by the shunt voltage detecting circuit with a reference value, if the current of the heating wire is lager than the reference value, to determine that an error occurs in the heating wire, to cut off power supplied to the heating wire and to display that the power is cut off.

33. The apparatus of claim 32, further comprising a reference voltage supply unit which supplies a uniform reference voltage to the controller regardless of a change in the commercial power.

34. The apparatus of claim 32, further comprising a selector which inputs a selection signal to the controller so as to selectively drive the at least two or more heating wires, respectively, wherein at least two or more heating wires are provided, and the heating wire driving unit, the shunt voltage detecting circuit, and the heat setting circuit are also provided to have a number corresponding to the number of the heating wires.

35. An apparatus for driving an electromagnetic-field-shielded heating wire used in bedding, the apparatus comprising:
a heating unit which generates heat if power is supplied to the heating unit and in which resistance is increased as temperature rises;
a safety circuit which cuts off power supply automatically if an overvoltage is generated to commercial power;
an electric-potential checking circuit which checks that an electromagnetic wave is generated in the heating unit, to allow a terminal to be grounded with the earth through a plug;
a constant-voltage circuit which rectifies and smoothens the commercial power supplied to the heating unit to supply a DC (direct current) power to each unit;
an output circuit which switches supply of the commercial power to the heating unit;
a temperature setting circuit which sets heating temperature of the heating unit;
a temperature detecting circuit which detects temperature of the heating unit;
an overcurrent protecting circuit which, if an overcurrent is generated in the heating unit through the temperature detecting circuit, outputs a control signal to the temperature setting circuit so that power cannot be supplied to the heating unit regardless of the set value of the temperature setting circuit;
a temperature comparing circuit which compares a voltage caused by temperature setting of the temperature setting circuit with a voltage caused by temperature detecting of the temperature detecting circuit and outputs a control signal so that the output circuit can supply or cannot supply the commercial power to the heating unit; and
a time generating circuit which, if the temperature comparing circuit outputs a control signal so that the commercial power cannot be supplied to the heating unit, controls the apparatus to supply the commercial power to the heating unit for a short time so as to detect temperature.

36. The apparatus of claim 35, wherein the heating unit includes a core wire, a heater wire formed of pure iron (Fe), and a shield wire or ground wire formed on an outer circumference of the heater wire.

37. The apparatus of claim 35, wherein the heating unit includes a heater wire which functions as a core wire and is formed of pure iron (Fe) and a shield wire or ground wire formed on an outer circumference of the heater wire.

38. The apparatus of claim 35, wherein the constant-voltage circuit includes a power display lamp which displays that the commercial power is supplied to the apparatus.

39. The apparatus of claim 35, wherein the electric-potential checking circuit includes an electric-potential checking guide wire, at least one amplification transistor, an electric-potential checking lamp, and an electric-potential checking button, and if an electromagnetic wave generated in the heating unit is amplified and the electric-potential checking button is touched, the electric-potential checking lamp emits light so as to allow a user to correct an insertion location of a plug.

40. The apparatus of claim 35, wherein the temperature detecting circuit includes a resistor and a condenser, if temperature of the heating unit is low, the temperature detecting circuit outputs a high voltage, and if temperature of the heating unit is high, the temperature detecting circuit outputs a lower voltage.

41. The apparatus of claim 35, wherein the overcurrent protecting circuit includes a voltage compensator, a detection diode, a driving transistor, and an overcurrent unit, senses that an overcurrent is generated in the heating unit through the temperature detecting circuit, and outputs a control signal used to cut off power supplied to the heating unit, to the temperature setting circuit.

42. The apparatus of claim 35, wherein the temperature comparing circuit includes a hysteresis resistor and a comparator, if a voltage outputted from the temperature detecting circuit is higher than a voltage outputted from the temperature setting circuit, the temperature comparing circuit outputs a control signal to the output circuit so that the commercial power can be supplied to the heating unit, und if the voltage outputted from the temperature detecting circuit is lower than the voltage outputted from the temperature setting circuit, the temperature comparing circuit outputs a control signal to the output circuit so that the commercial power cannot be supplied to the heating unit.

43. The apparatus of claim 35, wherein the time generating circuit includes a time generator which generates a uniform pulse signal, and a pulse driving transistor, and switches an output terminal and a ground terminal of the temperature comparing circuit according to the pulse signal.

44. The apparatus of claim 35, wherein the output circuit includes first, second, and third diodes, a transistor, a thyristor for output control, and an output display lamp, switches the commercial power supplied to the heating unit according to a control signal outputted from the temperature comparing circuit, and supplies the commercial power to the heating unit instantaneously by the time generating circuit.

45. The apparatus of claim 44, wherein one end of the heater wire of the heating unit is connected to a second terminal of the commercial power through the first diode and the thyristor for output control, one end of the core wire of the heating unit is connected to a first terminal of the commercial power, the other end of the heater wire is connected to the other end of the core wire through the second diode, and reverse discharge is prevented by the third diode.

46. The apparatus of claim 44, wherein the shield wire of the heating unit is connected to a first terminal of the commercial power together with the core wire.

47. The apparatus of claim 35, wherein the output circuit includes first, second, and third diodes, a transistor, a thyristor for output control, a wire wound resistor, and an output display lamp, switches the commercial power supplied to the heating unit according to a control signal outputted from the temperature comparing circuit, supplies the commercial power to the heating unit instantaneously by the time generating circuit, and prevents a peak voltage which may occur during an on/off operation of the thyristor by the wire wound resistor.
